(19) United States
(12) Patent Application Publication
(10) Pub. No.: US 2026/0308328 A1
(43) Pub. Date: Oct. 8, 2026

(54) CURABLE POLYSILOXANE COMPOSITION WITH HIGH THERMAL INSULATION PERFORMANCE AT HIGH TEMPERATURE

(71) Applicants: DOW SILICONES CORPORATION, Midland, MI (US); DOW GLOBAL TECHNOLOGIES LLC, Midland, MI (US)

(72) Inventors: Xuesi YAO, Shanghai (CN); Xiangyang TAI, Shanghai (CN); Minbiao HU, Shanghai (CN); Yi GUO, Shanghai (CN); Cheng LIU, Shanghai (CN)

(21) Appl. No.: 19/484,229

(22) PCT Filed: May 15, 2023
(86) PCT No.: PCT/CN2023/094299

§ 371 Date: Nov. 13, 2025

(51) Int. Cl. C08G 77/20; C08G 77/08; C08G 77/12; C08J 3/215; C08K 3/04; C08K 3/26; C08K 3/34

(52) U.S. Cl. CPC C08G 77/20; C08G 77/08; C08G 77/12; C08J 3/215; C08K 3/04; C08K 3/26; C08K 3/346; C08J 2383/04; C08K 2003/267; C08K 2201/011

(57) ABSTRACT

Provided is a curable polysiloxane composition comprising: (A) at least one organopolysiloxane having at least two alkenyl groups bonded to silicon per molecule in an amount of 100 parts by weight; (B) at least one organopolysiloxane having at least two hydrogen atoms bonded to silicon per molecule in an amount of from 0.5 to 20 parts by weight; (C) a hydrosilylation catalyst in a catalytic amount; (D) at least one flame retardant filler in an amount of from 2 to 150 parts by weight; and (E) water. Component (E) is dispersed as water droplets in a mixture of components (A), (B), (C) and (D), with an average droplet size of ≤100 μm. The composition has greatly increased thermal insulation performance at high temperature. A process for manufacturing a polysiloxane composite from the composition is also provided. The polysiloxane composite is useful as thermal insulation material and for thermal insulation.

### TECHNOLOGICAL FIELD OF THE PRESENT INVENTION

The present invention relates to a curable polysiloxane composition with high thermal insulation performance at high temperature. This invention also relates to a process for manufacturing a polysiloxane composite from the curable polysiloxane composition, and an article comprising a polysiloxane composite obtained from the curable polysiloxane composition for thermal insulation.

### BACKGROUND ART

Polysiloxane foam performs outstanding from other organic polymeric foam due to its stability in wide range of operating temperatures. Especially when application temperature goes above that triggering Si—O—Si bond dissociation (above 350° C.), silicone foam can be ceramified into inorganic porous material, and keep occupying the original space, therefore providing certain fire and heat protection. Under such high temperature, other polymeric foam, like polyurethane foam, polypropylene foam, polystyrene foam etc., goes for decomposition and can no longer providing any considerable protection. The combination of high cushion and flexibility at working temperature (<250° C.) with fire and heat protection performance at higher temperature (>350° C.) makes silicone foam unique and indispensable.

On the other hand, the demand for higher thermal insulation performance at high temperature is continuously increasing. In oil industry and energy storage applications, it requires thermal insulation performance to exceed inorganic materials. One key challenge is how to reduce the cell size of silicone foam since cell size is critical to thermal insulation property. In prior arts, chemically foamed liquid silicone rubber (LSR) usually uses hydrogen gas for foaming, which is usually generated by reacting OH group (usually on alcohol) with Si—H group on polydimethylsiloxane (PDMS). For example, Patent Document 1 disclosed a thermally insulative fire block sheet having an elastomeric layer. The elastomeric layer is cured silicone foam rubber with alumina trihydrate. It is foamed by H₂ generated from foam layer comprising: a silicone based matrix component, a flame retardant filler component, and an insulation filler component. In addition, Patent Document 2 disclosed composite to make close-cell silicone foam. The claimed composite comprises two parts. Part A comprises polysiloxane-containing vinyl 100 parts, hydrogen-containing silicone oil 2~8 parts, flame retarding filler 20~80 parts, reinforcing filler 2~10 parts. Part B comprises of polysiloxane-containing vinyl 114 parts, flame retarding filler 20~80 parts, reinforcing filler 2~6 parts, catalyst 0.2~1.2 parts and foaming agent 20~50 parts. Foaming agents are alcohol type of chemicals, which can react with Si—H group to generate H₂. In such processes, higher porosity and slower curing speed results to bigger cell size. Depending on final porosity and the relationship between curing kinetics and foaming kinetics, cell size varies in the range from 100 μm to several millimeters, but cannot achieve a smaller cell size of ≤100 μm. Silicone foam with such big size exhibits poor thermal insulation property.

When using high consistency silicone rubber (HCR) as foaming matrix, cell size of ≤100 μm can be achieved by adding azo-type of foaming agent powders. It decomposes and generates nitrogen gas for foaming. However, there is safety problem of the decomposition residual of foaming agent, and the odor is pungent, that limits its application. How to further boost the thermal insulation property with eco-friendly process remains a big challenge for silicone foam, especially for the application under high temperature.

There are also known approaches found in prior documents to prepare silicone foam with ecofriendly process. As an exemplary approach, Patent Document 3 disclosed silicone foam made by a water-in-oil (W/O) type emulsion. The emulsion composite contains an organo-polysiloxane (I) containing alkenyl group (in wt. pts) (100), a surfactant (1-300), hydrogenated organo-polysiloxane (II) (0.1-50), water (20-1500) and a platinum group catalyst. The composite is heated, so that components (I) and (II) are additionally reacted to form a wet foam from which water is removed to leave cells in cured silicone matrix. That is, in such approach, water is dispersed in silicone matrix as droplet, and when heated, such water will be removed and leave a lot of small pores (cells) in silicone matrix so as to form silicone foam. Thus, in such approach, water is used to create droplet in silicone matrix, instead of participating into chemical reaction to generate gas bubbles.

However, there are still some disadvantages remained in the process. Due to high hydrophobicity of silicone oil, it requires a significant amount of surfactant, as being disclosed in Patent document 3, to emulsify water in silicone oil for a stable emulsion with fine droplet and narrow droplet size distribution. Some surfactants can poison platinum catalyst, therefore deteriorate ceramification efficiency at temperature ≥350° C. Therefore, such process was not applied for silicone composite for high temperature in high temperature ceramification.

### Prior Art Documents

Patent Document 1: U.S. Pat. No. 4,822,659A
Patent Document 2: CN Patent Publication No. CN110591378A
Patent Document 3: JP Patent Publication No. JP2004091569A

### SUMMARY OF THE INVENTION

### Problem to be Solved by the Invention

In the silicone foam technology field, silicone foam having greatly increased thermal insulation performance is not well known. There are only a few prior arts (such as Patent Documents 1, 2, and 3) providing composites for silicone rubber, but all of them exhibit some disadvantages such as deteriorated thermal insulation property due to larger cell size and/or lower ratio of close cell, pungent odor due to chemical foaming process, deteriorated ceramification at high temperature, etc.

Accordingly, it is an object of the present invention to provide a curable polysiloxane composition, which has greatly increased thermal insulation performance at high temperature. Particularly, it is an object of the present invention to provide a curable polysiloxane composition, which can form a polysiloxane composite having a higher ratio of close cell and a reduced cell size of ≤100 μm by means of emulsion process.

Further, it is other objects of the present invention to provide a process for manufacturing a polysiloxane composite from the curable polysiloxane composition, the use of said polysiloxane composite as thermal insulation materials, as well as an article comprising a polysiloxane composite obtained from said curable polysiloxane composition for thermal insulation.

### Means for Solving the Problem

As a result of persistent investigation, the present inventors discovered a novel composite to greatly reduce the thermal conductivity of the resulted polysiloxane composite at temperature high enough to trigger Si—O—Si bond dissociation. The present invention is a product of this discovery.

One aspect of the present invention is a curable polysiloxane composition comprising of:
(A) at least one organopolysiloxane having at least two alkenyl groups bonded to silicon per molecule in an amount of 100 parts by weight;
(B) at least one organopolysiloxane having at least two hydrogen atoms bonded to silicon per molecule in an amount of 0.2-20 parts by weight;
(C) a hydrosilylation catalyst in a catalytic amount;
(D) at least one flame retardant filler in an amount of 2-250 parts by weight; and
(E) water;

wherein component (E) water is dispersed as water droplets in a mixture of said components (A), (B), (C) and (D), with the average droplet size of <100 μm.

In some embodiments, said curable polysiloxane composition further comprises (F) at least one thickener in an amount such that when adding component (F) thickener into component (E) water, obtained thickened water (M) has a viscosity in the range of 50,000-400,000 cst at 0.1s⁻¹, and 5,000-10,000 cst at 10s⁻¹.

In some embodiments, said curable polysiloxane composition further comprises (G) at least one emulsifier in an amount sufficient to promote the dispersion of component (E) water or thickened water (M) into water droplets with the average droplet size of 100 μm.

In some embodiments, said curable polysiloxane composition further comprises (H) at least one hydrosilylation catalyst inhibitor in an amount sufficient to inhibit the hydrosilylation catalyst at relatively lower temperature.

In some embodiments, said curable polysiloxane composition further comprises (I) at least one opacifier.

In some embodiments, component (E) water is comprised in an amount of 5-1,000 parts by weight, relative to 100 parts by weight of the total amount of said components (A), (B), (C), (D), (H) and (1).

In some embodiments, said organopolysiloxane (A) preferably comprises vinyl endblocked polyorganosiloxanes (i.e., vinyl-terminated PDMS) of the formula:

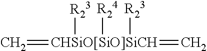

where R³ and R⁴ are selected from the group consisting of alkyl groups having from 1 to 6 carbon atoms per group, phenyl groups, and vinyl groups with at least 50 percent of R⁴ being methyl group.

In some embodiments, said organopolysiloxane (B) preferably comprises a copolymer of trimethylsiloxy and methylhydrogensilicones or a copolymer of trimethylsiloxy, methylhydrogensilicones and dimethylsilicones.

In some embodiments, said hydrosilylation catalyst (C) is preferably selected from, but not limited to, the group consisting of platinum, palladium, rhodium, nickel, iridium, ruthenium catalysts and mixtures thereof.

In some embodiments, said flame retardant filler (D) is preferably selected from, but not limited to, the group consisting of aluminum hydroxide, magnesium hydroxide, hydromagnesite, ammonium polyphosphate, melamine polyphosphate, piperazine polyphosphate and mixtures thereof.

In some embodiments, said thickener (F) is preferably selected from, but not limited to, the group consisting of nanoclay, cellulose, polyacrylate and mixtures thereof.

In some embodiments, said emulsifier (G) is preferably selected from but not limited to, the group consisting of polysiloxane polyether, alkyl-poly(ethylene oxide) and mixtures thereof.

In some embodiments, said opacifier (I) is preferably selected from but not limited to, the group consisting of carbon black, Fe₃O₄ and mixtures thereof.

A second aspect of the present invention is a process for manufacturing a polysiloxane composite from the curable polysiloxane composition described in the first aspect, comprising following steps:

Step (I): a mixing step of mixing component (A) with other components (B), (C), (D) and optional components (H), (I) to form a silicone oil composite mixture (N), then adding component (E) water and applying enough shearing and time to disperse said water into water droplets in the silicone oil composite mixture (N), and thereby making a water-in-oil emulsion;

Step (II): a heating step of heating the water-in-oil emulsion made in the above step (I) at certain temperature and time, which is enough to conduct curing of the silicone oil composite mixture (N) into a silicone matrix through the reaction between alkylene group in component (A) and Si—H group in component (B), and thereby making a cured wet composite with water droplets dispersed in; and

Step (III): a drying step of removing water from the cured wet composite made in the above step (II) by raising heating temperature above water's boiling point at the operation condition and allowing enough time to remove water from the cured wet composite, and thereby obtaining a dried polysiloxane composite.

In some embodiments, prior to step (I), thickened water (M) is previously prepared by adding component (F) thickener into component (E) water, and then in step (I), instead of component (E) water, said thickened water (M) is added into said silicone oil composite mixture (N) to make a water-in-oil emulsion.

In some embodiments, the dried polysiloxane composite obtained in said Step (III) has an mean cell size of ≤100 μm.

A Third aspect of the present invention is use of the polysiloxane composite obtained in the second aspect as thermal insulation materials.

A fourth aspect of the present invention is an article comprising the polysiloxane composite obtained in the second aspect.

### Effect of the Invention

The present invention is able to provide a curable polysiloxane composition, which has greatly increased thermal insulation performance at high temperature, which can form a polysiloxane composite having a higher ratio of close cell and a reduced cell size of ≤100 μm by means of the emulsifying, curing and drying process, and also to provide a process for manufacturing a polysiloxane composite from the curable polysiloxane composition, the use of said polysiloxane composite as thermal insulation materials, as well as an article comprising a polysiloxane composite obtained from said curable polysiloxane composition for thermal insulation.

Furthermore, the invention reveals a breakthrough technology for silicone composite in thermal insulation application. With the realization of silicone composite with excellent thermal insulation performance, it opens a new product area for silicone rubber makers to satisfy the needs for high thermal insulation performance in varieties of applications, like battery fire protection.

### BRIEF DESCRIPTION OF THE DRAWINGS

FIG. 1 is an illustration of comparative cut bar technology for testing thermal conductivity performance of the polysiloxane composite according to the present disclosure.

FIG. 2 is SEM image of Comparative Example 1 according to the present invention.

FIG. 3 is SEM image of Comparative Example 2 according to the present invention.

FIG. 4 is SEM image of Inventive Example 1 according to the present invention.

FIG. 5 is SEM image of Inventive Example 2 according to the present invention.

FIG. 6 is SEM image of Inventive Example 3 according to the present invention.

FIG. 7 is SEM image of Inventive Example 4 according to the present invention.

### DESCRIPTION OF THE PREFERRED EMBODIMENTS

Unless defined otherwise, all technical and scientific terms used herein have the same meaning as commonly understood by one of ordinary skill in the art to which the invention belongs. As disclosed herein, “and/or” means “and, or as an alternative” or “additionally or alternatively”. All ranges include endpoints unless otherwise indicated.

As used herein, the term “thickness” refers to an average of at least three measurements of a dried sheet (e.g., a sheet having a thickness of 0.2-10.0 mm) as measured using an Ames Gage, Model 13C-B2600 (Ames Corporation Waltham Mass).

As used herein, the term “polymer” or “polymeric” refers, in the alternative, to a polymer made from one or more different monomers, such as a copolymer, a terpolymer, a tetrapolymer, a pentapolymer etc., and may be any of a random, block, graft, sequential or gradient polymer.

In the present invention, the singular form of the articles “a,” “an,” and “the” includes plural references unless indicated otherwise. In the present invention, the terms “comprise”, “comprising”, “contain”, “containing”, “include”, “including” and their variants are open claim language, i.e., are permissive of additional elements.

In the present invention, a curable polysiloxane composition, which has greatly increased thermal insulation performance at high temperature is provided. Here, the term “high temperature” has the same meaning as commonly understood by one of ordinary skill in the art, and particularly, in the present invention, it preferably means a temperature high enough to trigger Si—O—Si bond dissociation.

Specifically, curable polysiloxane composition of the present invention comprises, substantially consists of, or consists of: (A) at least one organopolysiloxane having at least two alkenyl groups bonded to silicon per molecule in an amount of 100 parts by weight; (B) at least one organopolysiloxane having at least two hydrogen atoms bonded to silicon per molecule in an amount of 0.5-20 parts by weight; (C) a hydrosilylation catalyst in a catalytic amount; (D) at least one flame retardant filler in an amount of 2-150 parts by weight; and (E) water in an amount of 5-1,000 part; wherein component (E) water is dispersed as water droplets in a mixture of said components (A), (B), (C) and (D), with the average droplet size of ≤100 μm.

In some preferable embodiments, curable polysiloxane composition of the present invention optionally comprises (F) at least one thickener; (G) at least one emulsifier; (H) at least one hydrosilylation catalyst inhibitor; and/or (I) at least one opacifier.

### Component (A)

In the present invention, component (A) is well-known in the art; and examples thereof comprises alkenyl endblocked polyorganosiloxanes (i.e., vinyl-terminated PDMS) of the formula:

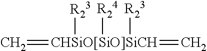

where R³ and R⁴ are selected from the group consisting of alkyl groups having from 1 to 6 carbon atoms per group, phenyl groups, and alkenyl groups with at least 50 percent of R⁴ being methyl group. Preferably, the viscosity of component (A) is from 100 cst to 200,000 cst, from 1,000 cst to 100,000 cst, from 5,000 cst to 50,000 cst, from 8,000 cst to 16,000 cst, from 8,000 cst to 14,000 cst, from 8,000 cst to 12,000 cst or from 8,000 cst to 10,000 cst at 25° C.

In some embodiments of the present disclosure, the alkenyl groups contained in component (A) may comprise from 2 to 14 carbon atoms, 4 to 12 carbon atoms or 6 to 10 carbon atoms; preferably, the alkenyl groups are chosen from the group consisting of vinyl, allyl, hexenyl, decenyl and tetradecenyl, and most preferably the alkenyl groups are vinyl groups.

In the present disclosure, the amount of component (A) is defined as 100 parts by weight, and unless defined otherwise, the amounts of other components are all based on 100 parts by weight of component (A).

### Component (B)

In the present invention, component (B) may be used to adjust crosslink density and can be any silicones having an average of at least two silicon-bonded hydrogen atoms per molecule. The remaining valences of the silicon atoms are satisfied by divalent oxygen atoms or by monovalent alkyl radicals having from 1 to 6 carbon atoms per radical, such as methyl, ethyl, propyl, isopropyl, butyl, and hexyl and phenyl groups. The organohydrogensilicones can be homopolymers, copolymers, and mixtures thereof. Preferably, the organohydrogensilicones comprises, but not limited to, a copolymer of trimethylsiloxy and methylhydrogensilicones or a copolymer of trimethylsiloxy, methylhydrogensilicones and dimethylsilicones.

In an embodiment of the present invention, the organohydrogensilocones have an average of at least three silicon-bonded hydrogen atoms per molecule. In an embodiment of the present invention, the viscosity of component (B) is from 1 cst to 500 cst, from 2 cst to 300 cst, from 5 cst to 100 cst, from 10 cst to 80 cst, from 10 cst to 60 cst, from 10 cst to 40 cst or from 10 cst to 20 cst at 25° C. In an embodiment of the present invention, component (B) comprises 0.01-1.67 wt %, 0.02-1.5 wt %, 0.05-1.3 wt %, 0.1-1.1 wt %, 0.2-1.0 wt %, 0.4-0.8 wt % or 0.5-0.6 wt % SiH. In an embodiment of the present invention, component (B) is hydrogenated silicone oil having a viscosity 20 cst at 25° C. and about 1.6 wt % SiH.

With particular preference, component (B) may have an amount of 0.2-20 parts by weight, 0.5-18 parts by weight, 1-16 parts by weight, 2-14 parts by weight, 5-10 parts by weight, 7-9 parts by weight, based on 100 parts by weight of component (A).

### Component (C)

In the present invention, component (C) can be selected from the group consisting of platinum, palladium, rhodium, nickel, iridium, ruthenium catalysts and mixtures thereof, preferably platinum catalyst, which can efficiently promote the reaction of —SiH groups with vinyl groups. Particularly preferred is a two-component curable silicone composition wherein the catalyst is an organoplatinum compound. Particularly preferred is a two-component curable silicone composition wherein the catalyst is functional organoplatinum compound selected from an (η-diolefin) (α-aryl) platinum complex, an (η-diolefin) (γ-aryl)-platinum complex, an (η-diolefin) (γ-alkyl)-platinum complex, and mixtures thereof. It is possible to use commercially available products in the present invention.

In the present invention, component (C) is used in a catalytic amount, i.e., an amount that is sufficient for component (C) to catalyze the hydrosilylation reaction between components (A) and (B). With particular preference, component (C) may have an amount of 0.1-2 parts by weight, 0.5-1.5 parts by weight, 0.8-1.3 parts by weight, 0.9-1.1 parts by weight, based on 100 parts by weight of component (A).

### Component (D)

In the present invention, component (D) can further improve flame retardancy. Generally, there is present from 2 to 250 percent by weight, from 5 to 200 percent by weight, from 10 to 150 percent by weight, from 15 to 120 percent by weight, from 15 to 100 percent by weight, from 20 to 80 percent by weight or from 30 to 50 percent by weight of flame retardant filler, based on 100 parts by weight of component (A), which depends on flame retardant requirement of the polysiloxane composite. If the amount of component (D) is too little, it may result to insufficient thermal insulation performance. If the amount of component (D) is too much, it may result to bad processability or poor mechanical performance.

The flame retardant filler may comprises those generally used in silicone foams, and may include, but not limited to, aluminum hydroxide, magnesium hydroxide, hydromagnesite, ammonium polyphosphate, melamine polyphosphate, piperazine polyphosphate and mixtures thereof.

### Component (E)

In the present invention, component (E) is introduced into the silicone-based matrix under a condition of mixing or, preferably, mixing and shearing, mixing and agitating or a combination of mixing, shearing and agitating, so as to give a water-in-oil emulsion, in which the water droplets have an average droplet size of ≤100 μm, ≤80 μm, ≤50 μm, ≤30 μm, ≤10 μm or ≤5 μm. Preferably, the average droplet size is greater than or equal to 100 nm, 300 nm, 500 nm, 800 nm or 1 μm.

In accordance with the present invention, the mixing, shearing and/or agitating may be carried out by any conventional means for forming a mortar or simple mixing. For example, component (E) may be mixed by hand or with a low shear mixer, such as a cement mixer, a static mixer or a medium or high shear mixer, such as a homogenizer or other conventional foam mixing device.

Differentiated from the prior arts in which water is used as a chemical foaming agent in a relatively small amount, e.g., 0.1% to 5% by weight based on the total amount of the curable silicone-based composition, component (E) in the present invention has much greater amount based on the total amount of the silicone-based matrix. In some embodiments of the present invention, the amount of component (E) is 5~1,000 parts by weight, 10~800 parts by weight, 10~500 parts by weight, 10~300 parts by weight, 10~150 parts by weight, 20~130 parts by weight, 30~110 parts by weight, 40~100 parts by weight, 50~90 parts by weight, or 60~70 parts by weight, based on 100 parts by weight of component (A).

### Component (F)

To promote dispersing of the water droplets in relatively small mean cell size, applying much more amount of component (E) ino the curable polysiloxane composition and thereby preserve consistency and homogeneity of the water-in-oil emulsion, one or more thickeners may be included. The thickener is a component that thickens water of the present invention to improve consistency, homogeneity, workability and storage stability. The thickener according to the present invention includes one or more types selected from water-soluble organic polymers, clay minerals or a mixture thereof.

Examples of water-soluble organic polymers can include high-molecular polysaccharides, water-soluble acrylic resins, and the like. In particular, the use of a water-soluble organic polymer containing a carboxylate group is preferred, and preferred examples include polyacrylates, which are carboxyl-containing attached polymers, such as sodium polyacrylates, sodium polymethacrylates, and the like.

The clay mineral may be natural or synthetic, and examples include natural or synthetic smectite clay such as bentonite, montmorillonite, hectorite, saponite, soconite, bidelite, nontronite, and the like; and aluminum silicate magnesium are exemplified. Smectite clay such as bentonite, montmorillonite, and the like are preferred. Such smectite clays are available, for example, as SUMECTON SA (manufactured by Kunimine Industries Co., Ltd.), which is a hydrothermally synthesized product, and BEN-GEL (manufactured by HOJUN., Co. Ltd.), which is a naturally refined product. Note that these clay minerals may be synthetic smectite clays, and the synthetic smectite clays generally have a smaller particle size than natural smectite clays. For example, the average particle size is only 5 or 10% of the average particle size of natural smectite. Synthetic smectite clays have such small particle sizes, and therefore can be added in a smaller amount than natural smectite clays to produce a highly viscous aqueous gel composition. The pH of these clay minerals such as smectite clay and the like is preferably within a pH range of 5.0 to 9.0.

The water-soluble organic polymer is a component which can be modified by mixing with the clay mineral, and forms a hydrophilic composite with the clay mineral. Note that in the present invention, only one type selected from the water-soluble organic polymers or the clay minerals may be used, but both may be and are preferably used in a mixture.

The clay mineral, such as a bentonite or montmorillonite, may be modified by premixing with the water-soluble organic polymer. For example, the clay mineral and water-soluble organic polymer may be uniformly mixed in water, and the mixture may then be dried, for example by spray drying. The resulting dry mixture may be ground, if necessary, to a desired particle size, which may be within a range of 1 to 20 μm. The amount of water-soluble polymers in such a mixture may range, for example, from 0.1 wt % to 40 wt %.

Exemplary thickeners of the present invention includes, but not limited to, nanoclay, cellulose, polyacrylate, a hydrophobically modified anionic thickener, a hydrophobically modified alkali swellable emulsion (HASE), for example, hydrophobically modified acrylic acid copolymers such as ACRYSOL® TT935 (Dow). A hydrophobically modified acrylic acid copolymer comprises two or more hydrophobic groups, such as an aryl or phenyl group, or a C 4 or higher alkyl group.

In some embodiments of the present invention, the thickeners are firstly added into component (E) to provide a thickened water (M). The total amount of thickeners may range from 0.2 to 5 parts by weight, 0.5 to 5 parts by weight, from 1 to 4 parts by weight, from 2 to 3 parts by weight, based on 100 parts by weight of component (E). If the amount of the thickener exceeds the upper limit described above, the viscosity of thickened water (M) may become excessively high, it becomes difficult to disperse water into silicone oil composite mixture (N), and makes the processability deteriorated.

The thickening performance of the thickener is not particularly limited, but from the perspective of a technical effect of the present invention, thickening properties are preferably provided, where thickened water (M) has a viscosity in the range of 5,000-1,000,000 cst, 20,000-800,000 cst, 50,000-500,000 cst, 100,000-300,000 cst or 150,000-250,000 cst at 25° C. and 0.1s⁻¹; and a viscosity in the range of 1,000-10,000 cst, 3,000-9,000 cst, 5,000-8,000 cst or 6,000-7,000 cst at 25° C. and 10s⁻¹.

### Component (G)

Also to promote dispersing of the water droplets in relatively small mean cell size and thereby preserve consistency and homogeneity of the water-in-oil emulsion, one or more emulsifiers may also be included. Just like thickeners, emulsifiers can also improve consistency, homogeneity, workability and storage stability.

In preferred embodiments, the emulsifier is nonionic emulsifier. In more preferred embodiments, said emulsifier can be selected from the group consisting of polysiloxane polyether, alkyl-poly(ethylene oxide), polyoxyethylene-polyoxypropylene copolymer and mixtures thereof.

For example, the polyoxyethylene-polyoxypropylene copolymer nonionic emulsifier is usually a compound expressed by the following general formula (1) or general formula (2).

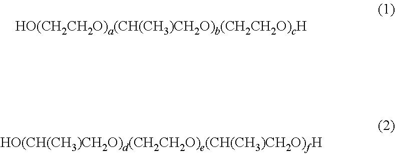

In general formulae (1) and (2), a, b, c, d, e and f are the average number of mols of ethylene oxide or propylene oxide added, and are each independently a number between 1 and 350. The weight average molecular weight of the polyoxyethylene-polyoxypropylene copolymer is preferably 1,000 to 18,000, and more preferably 1,500 to 10,000. Component (G) can be used in an aqueous solution, if in a solid form.

More specific examples of compounds serving as component (G) include the Pluronic (registered trademark) L series, Pluronic (registered trademark) P series, Pluronic (registered trademark) F series, and Pluronic (registered trademark) TR series manufactured by ADEKA CORPORATION; Emulgen PP-290 manufactured by Kao Corporation; and Newcol 3240 manufactured by Nippon Nyukazai Co., Ltd., which are available on the market.

In some embodiments of the present invention, the emulsifier (G) is free of any ionic emulsifier. In general, an anionic surfactant, cationic surfactant and/or amphoteric surfactant can be used as an ionic emulsifier. So in the present invention, the curable silicone-based composition can be substantially free of any surfactants. Examples of anionic surfactants include alkylbenzene sulfonate, alkyl ether sulfate, polyoxyethylene alkyl ether sulfate, polyoxyethylene alkyl phenyl ether sulfate, alkyl naphthyl sulfonate, unsaturated aliphatic sulfonate, and hydroxylated aliphatic sulfonate. Examples of cationic surfactants include quaternary ammonium type salt surfactants, such as: octadecyl trimethyl ammonium chloride, hexadecyl trimethyl ammonium chloride, and other alkyl trimethyl ammonium salts; dioctadecyldimethyl ammonium chloride, dihexadecyldimethyl ammonium chloride, didecyldimethyl ammonium chloride, and other dialkyldimethyl ammonium salts; and the like. Examples of amphoteric surfactants include alkylbetaines and alkylimidazolines.

In some embodiments of the present invention, the emulsifiers are firstly added into silicone oil composite mixture (N). The total amount of emulsifiers can be within a range of 0.2 to 5 parts by weight, 0.5 to 5 parts by weight, 1 to 4 parts by weight, 2 to 3 parts by weight, based on 100 parts by weight of component (A). If the amount of the emulsifier exceeds the upper limit described above, it deteriorates the mechanical strength of final curable polysiloxane composition.

### Component (H)

In the present invention, the hydrosilylation catalyst inhibitor is an optional component, which can slow the reaction rate by inhibiting the hydrosilylation catalyst as needed so that mixing can be completed before the mixture starts curing reaction. Therefore, it shall be understood that in case curing is not to be conducted quickly during and right after mixing, it may become necessary to add component (H), but in case curing can be conducted immediately right after mixing, it may not need to add component (H). Determining whether it needs to add component (H) into the curable polysiloxane composition is within the capability of one of ordinary skill in the art.

Examples of the hydrosilylation catalyst inhibitor comprise methylvinylcyclosiloxane, tetravinyltetramethyl-cyclotetrasiloxane (vinyl D4), ethynylcyclohexanol (ECH) and mixtures thereof. With particular preference, the hydrosilylation catalyst inhibitor may be incorporated into the curable polysiloxane composition in an amount sufficient to inhibit the hydrosilylation catalyst, e.g., in an amount of from 0% to 2% by weight, from 0.05% to 1.5% by weight or from 0.5% to 1.2% by weight, such as 0.1% by weight, based on the total amount of the curable polysiloxane composition, which depends on desired curing speed.

In some embodiments of the present invention, the amount of component (H) is 0.05-2 parts by weight, 0.1-1.5 parts by weight, 0.5-1.0 parts by weight or 0.7-0.9 parts by weight, based on 100 parts by weight of component (A).

### Component (I)

In the present invention, component (I) is one or more opacifiers which can absorb, scatter and reflect thermal radiation. The particle size of these opacifiers can be in the range of 0.2-50 μm, 0.5-20 μm, 1-10 μm or 2-5 μm. Examples of the opacifiers are titanium oxides, zirconium oxides, ilmenites, iron titanates, iron oxides, zirconium silicates, silicon carbide, manganese oxides and carbon black or any combination thereof. In one embodiment, carbon black or Fe₃O₄ can be utilised as the opacifier. Component (I) is typically present in an amount of from 0.2 to 20 wt %, alternatively from 1 to 15 wt %, alternatively 2 to 12 wt %, based on the total amount of the curable silicone-based composition. Component (I) is available commercially.

Process for Manufacturing a Polysiloxane Composite from the Curable Polysiloxane Composition

In the present invention, a process for manufacturing a polysiloxane composite from the curable polysiloxane composition described above is also provided. The manufacturing process comprises following steps:

Step (I): a mixing step of mixing component (A) with other components (B), (C), (D) and optional components (H), (I) to form a silicone oil composite mixture (N), then adding component (E) water and applying enough shearing and time to disperse said water into water droplets in the silicone oil composite mixture (N), and thereby making a water-in-oil emulsion;

Step (II): a heating step of heating the water-in-oil emulsion made in the above step (I) at certain temperature and time, which is enough to conduct curing of the silicone oil composite mixture (N) into a silicone matrix through the reaction between alkylene group in component (A) and Si—H group in component (B), and thereby making a cured wet composite with water droplets dispersed in; and

Step (III): a drying step of removing water from the cured wet composite made in the above step (II) by raising heating temperature above water's boiling point at the operation condition and allowing enough time to remove water from the cured wet composite, and thereby obtaining a dried polysiloxane composite.

Step (I) is a step for preparing a water-in-oil emulsion by dispersing component (E) water into water droplets in a silicone oil composite mixture (N) of components (A), (B), (C), (D) and optional components (H), (I). In some embodiments, said step (I) is a step of introducing component (E) water into the silicone oil composite mixture (N) under a condition of mixing or, preferably, mixing and shearing, mixing and agitating or a combination of mixing, shearing and agitating, so as to give a water-in-oil emulsion, in which the water droplets have an average droplet size of ≤100 μm, ≤80 μm, ≤50 μm, ≤30 μm, ≤10 μm or ≤5 μm. Preferably, the average droplet size is greater than or equal to 100 nm, 300 nm, 500 nm, 800 nm or 1 μm.

In some preferable embodiments, prior to step (I), thickened water (M) is previously prepared by adding component (F) thickener into component (E) water, and then in step (I), instead of component (E) water, said thickened water (M) is added into said silicone oil composite mixture (N) to make a water-in-oil emulsion.

In some more preferable embodiments, the viscosity of the silicone oil composite mixture (N) is in the range of 100-200,000 cst at 0.1s⁻¹, 300-150,000 cst at 0.1s⁻¹, 500-100,000 cst at 0.1s⁻¹, 1,000-80,000 cst at 0.1s⁻¹, 3,000-50,000 cst at 0.1s⁻¹, or preferably 5,000-30,000 cst at 0.1s⁻¹. In some further preferable embodiments, the ratio of viscosity of thickened water (M) to said silicone oil composite mixture (N) is 1-60 at 0.1s⁻¹, preferably 5-30 at 0.1s⁻¹. If the viscosity of the silicone oil composite mixture (N) as well as the ratio of viscosity of thickened water (M) (or component (E) water) to said silicone oil composite mixture (N) both fall within the above ranges, it will become easier to disperse said thickened water (M) (or component (E) water) into water droplets in the silicone oil composite mixture (N), and thus, the processability may be improved thereby.

Step (II) is a step for conducting curing of said water-in-oil emulsion through the reaction between alkylene group and Si—H group. In some embodiments, said step (II) is a step of heating the water-in-oil emulsion made in the above step (I) at a temperature ranging from 50° C. to 200° C. for a period of time, for example, 5 mins to 24 hours. However, in the present invention, the temperature and time are not particularly limited into the above ranges, but can be determined as needed, as long as they are enough to conduct curing of the silicone oil composite mixture (N) into a silicone matrix through the reaction between alkylene group in component (A) and Si—H group in component (B). By curing, the water-in-oil emulsion forms a cured wet composite with water droplets dispersed in. Any techniques for avoiding significant water evaporation, e.g., high pressure and/or sealed reactor, can be used during the curing.

Step (III) is a step for obtaining a dried polysiloxane composite by removing water from the cured wet composite made in the above step (II). That is, when the curing is complete, water can be removed from the cured wet composite by raising the temperature above boiling point of water at the operation condition, allowing enough time to remove water from the cured wet composite. According to the process of the present invention, the dried polysiloxane composite obtained in step (III) can have a mean cell size of c 100 μm. By such a smaller cell size, the dried polysiloxane composite of the present invention can exhibit greatly increased thermal insulation performance at high temperature.

In some embodiments, the dried polysiloxane composite obtained in step (III) can also have a higher ratio of close cell, such as a close cell percentage of ≥50%. By such a higher ratio of close cell, the dried polysiloxane composite of the present invention can exhibit more greatly increased thermal insulation performance at high temperature.

Further, since the dried polysiloxane composite of the present invention is prepared by means of emulsifying, curing, and drying process rather than chemical foaming process, its manufacturing process will have process benefit of operator-friendly without generating odor and operation safety without generation of hydrogen gas.

### Use of the Polysiloxane Composite

As described above, the polysiloxane composite of the present invention and/or the polysiloxane composite obtained in the manufacturing process of the present invention can exhibit greatly increased thermal insulation performance at high temperature. Therefore, they can be preferably used as thermal insulation materials. For example, the heat transfer from outside to the substrate to be protected in oil industry or electric vehicle during fire and explosion accidents, could be greatly delayed by applying the polysiloxane composite of the present invention as protective layer, which exhibits greatly increased thermal insulation performance at high temperature.

### EXAMPLES

The following is a more detailed description of the present invention with reference to examples. The present invention, however, is not restricted to these examples. All parts and percentages are by weight unless otherwise specified.

### [Density]

The Density of the polysiloxane composite was measured according to ASTM D792.

### [Mean Cell Size]

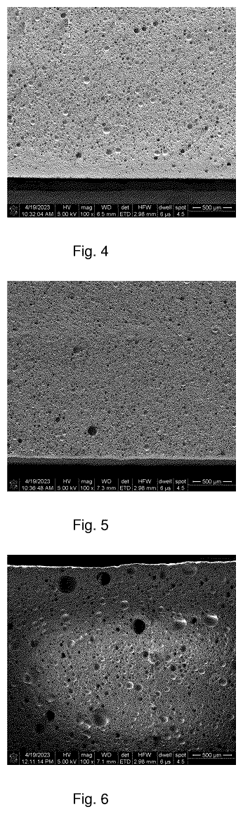

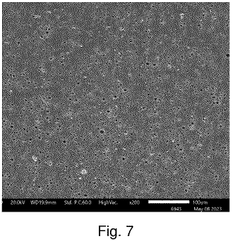

Deep learning-based segmentation method was adopted to segment the polysiloxane composite SEM images. FIG. 2-7 show SEM images of Comparative Examples 1-2 (also abbreviated as “CE1” and “CE2”, respectively) and Inventive Examples 1-4 (also abbreviated as “IE1”, “IE2”, “IE3” and “IE4”, respectively) according to the present invention, respectively. This technique can precisely segment pores from a diverse range of image formats without requiring model retraining or parameter adjustments. The neural network utilized in this process is based on the U-Net architecture, and the model has been trained on a dataset of over 70,000 segmented objects from highly varied microscopy images. The resulting model can generate a mask that features multiple labeled image regions. The scikit-image toolkit is utilized to analyze the mask and generate properties of the labeled image regions. The toolbox is built using python 3.8 and relies on dependencies such as pytorch, numpy, scipy, and scikit-image. Details are also described in website “https://arxiv.org/abs/1505.04597v1” with a name of “U-Net: Convolutional Networks for Biomedical Image Segmentation”.

### [Tensile Strength]

The tensile strength of the polysiloxane composite was measured according to CTM 0137A.

### [Elongation]

The elongation of the polysiloxane composite was measured according to CTM 0137A.

### [Thermal Conductivity Test]

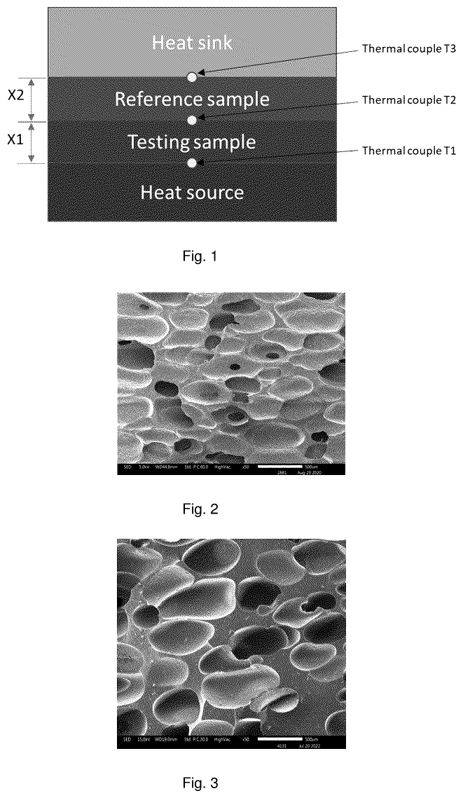

The thermal conductivity of the polysiloxane composite was tested by so called “Comparative cut bar technique”. FIG. 1 illustrated said comparative cut bar technology. Specifically, since heat flux going through both samples is the same, by measuring surface temperature and thickness of both samples, thermal conductivity can be calculated via equation 1.

$${λ}_{test} = {λ}_{refer} \frac{( T 2 - T 3 ) * {x}_{1}}{( T 2 - T 1 ) * {x}_{2}} \qquad [ Equation 1 ]$$

Here the surface areas of heat source, testing sample and reference sample are same. Thermal insulation pad with known thermal conductivity is used as reference sample to calculate the thermal conductivity of test sample. Here the reference sample was TOMBO 6702 sheet with ~2 mm in thickness which was obtained from NICHIAS corporation in Japan, to give stable thermal conductivity 0.1 w/(m·k) @400° C. and 0.11 w/(m·k) @600° C.

The heating test will last 20 mins for one test sample. The values of T1, T2, T3 and X1, X2 at 20 mins will be recorded and used to calculate the thermal conductivity λₜₑₛₜ.

The information of the raw materials used in Examples is listed in the following Table 1:

TABLE 1
Raw materials used in Examples

| Ingredient | |
|---|---|
| Type | Chemical Description, Chemical formula, or Structure |
| Polymer | Vinyl-terminated PDMS, viscosity 60,000 cst, vinyl |
| | content: 0.09 wt % |
| Filler | Hydromagnesite, d₅₀ 4 μm |
| Resin | Blend of PDMS and resin, 35% resin, viscosity 5,000 |
| | cst, vinyl content: 0.88 wt % |
| Pigment | Blend of PDMS and carbon black, 50% carbon black |
| Catalyst | Platinum catalyst |
| Inhibitor | Cyclic methyl-vinyl siloxane, D4 |
| Blowing agent | Benzyl alcohol |
| Crosslinker-1 | Copolymer of methyl-hydro siloxane and dimethyl |
| | siloxane, Si-H content: 0.69 wt % |
| Crosslinker-2 | Polymethylhydrosiloxane, Si-H content: 1.61 wt % |
| Thickener | Sodium bentonite |

### Inventive Examples 1-4 (IE 1-4) and Comparative Examples 1-2 (CE 1-2)

In Inventive Examples 1-4 and Comparative Example 2 of the present disclosure, the polysiloxane composites were produced using those raw materials and their amounts described in Table 2. Comparative Example 1 was provided here as control.

TABLE 2
Formulations used in Inventive Examples
and Comparative Examples

| | | | | | | |
|---|---|---|---|---|---|---|
| Ingredient Type | CE1 | CE2 | IE1 | IE2 | IE3 | IE4 |

Part A:

| | | | | | | |
|---|---|---|---|---|---|---|
| Resin | 28 | 85 | 85 | 85 | 85 | 81.5 |
| Polymer | 21 | | | | | 7.5 |
| Filler | 42 | 15 | 15 | 15 | 15 | 7.5 |
| Pigment | 7.2 | | | | | 3.5 |
| Inhibitor | | | 0.1 | 0.1 | 0.1 | 0.1 |
| Catalyst | 0.4 | 0.5 | 0.1 | 0.1 | 0.1 | 0.1 |
| Blowing agent | 1.4 | 0.5 | | | | |

Part B:

| | | | | | | |
|---|---|---|---|---|---|---|
| Polymer | 8 | | | | | |
| Resin | 3.5 | | | | | |
| Inhibitor | | 0.1 | | | | |
| Crosslinker-2 | 3 | 4 | | | | |
| Crosslinker-1 | 2 | | 5 | 5 | 5 | 5 |

Part C:

| | | | | |
|---|---|---|---|---|
| Water | 50 | 100 | 150 | 30 |
| Thickener | 0.75 | 1.50 | 2.25 | |

### Silicone Composite Formulation Preparation:

Part A: All ingredients were mixed in SpeedMixer at 1500 rpm for 2 min with vacuum.

Part B: All ingredients were mixed in SpeedMixer at 1500 rpm for 2 min with vacuum.

Part C: All ingredients were mixed with agitator at 1500 rpm for 10 min.

### Silicone Composite Fabrication:

### H₂-Blowing Foam (CE 1-2):

Part A and B were mixed using Speedmixer at 1500 rpm for 30s. Then the mixture was casted into a sheet with desired thickness between two PET films. The sheet was cured and foamed in an oven at 70° C. for 10 min. The foamed silicone sheet was delaminated from PET films and post-cured in an oven at 170° C. for 30 min. After post-curation, the properties and performances of polysiloxane composite sheet were measured.

### Water-Templated Silicone Composite (IE 1-4):

Part A and B were mixed using Speedmixer at 1500 rpm for 30s. Part C was hand-mixed into the mixture and then Speed-mixed at 1500 rpm for 30s with vacuum. The mixture was then casted into a sheet with desired thickness between two PET films. The sheet was cured in an oven at 80° C. for 10 min. The cured silicone composite was delaminated from PET films and dried in an oven at 180° C. for 60 min to remove water. After water was removed, the properties and performances of silicone composite were measured. Measurement results are shown in Table 3.

TABLE 3
Summary of properties of examples

| | Performance | | | | | | | |
|---|---|---|---|---|---|---|---|---|
| | Criteria | | CE1 | CE2 | IE1 | IE2 | IE3 | IE4 |
| Density (g/cm³) | <0.9 | | 0.50 | 0.52 | 0.76 | 0.54 | 0.42 | 0.82 |
| Mean Cell Size | ≤100 | um | 300 | 400 | 14 | 16 | 16 | 4 |
| (μm) | | | | | | | | |
| Tensile strength | ≥1 | Mpa | 0.41 | 0.45 | 4.94 | 3.94 | 3.10 | 3.20 |
| (MPa) | | | | | | | | |
| Elongation (%) | ≥30% | | 124.0 | 16.8 | 54.4 | 51.1 | 41.8 | 63.1 |
| Thermal | ≤0.15 | W/m · K | 0.211 | 0.178 | 0.092 | 0.103 | 0.105 | 0.103 |
| conductivity at | | | | | | | | |
| 600° C., (W/m · K) | | | | | | | | |

As shown in Table 3, CE 1-2 are traditional H₂-blowing silicone foams with 300 to 400 μm cell size. They have higher thermal conductivity and worse thermal insulation performance measured at 600° C., compared with IE 1-4, whose cell size is much smaller.

By contrast, IE1-4 has lower thermal conductivity and better thermal insulation performance. Meanwhile, due to micro-cell structure its tensile strength is much higher than CE 1-2. IE 1-4 have similar composition as CE2, while CE2 has much lower elongation.

1. A curable polysiloxane composition comprising of:
(A) at least one organopolysiloxane having at least two alkenyl groups bonded to silicon per molecule in an amount of 100 parts by weight;
(B) at least one organopolysiloxane having at least two hydrogen atoms bonded to silicon per molecule in an amount of from 0.2 to 2 parts by weight;
(C) a hydrosilylation catalyst in a catalytic amount;
(D) at least one flame retardant filler in an amount of from 2 to 250 parts by weight; and
(E) water;
wherein component (E) is dispersed as water droplets in a mixture of components (A), (B), (C) and (D), with an average droplet size of ≤100 m.

2. The curable polysiloxane composition according to claim 1, further comprising:
(F) at least one thickener in an amount such that when adding component (F) into component (E), obtained thickened water (M) has a viscosity in the range of 50,000 to 400,000 cst at 0.1s⁻¹, and 5,000 to 10,000 cst at 10s⁻¹.

3. The curable polysiloxane composition according to claim 1, further comprising:
(H) at least one hydrosilylation catalyst inhibitor in an amount sufficient to inhibit the hydrosilylation catalyst (C).

4. The curable polysiloxane composition according to claim 1, further comprising:
(I) at least one opacifier.

5. The curable polysiloxane composition according to claim 1, wherein component (E) is present in an amount of from 5 to 1,000 parts by weight, relative to 100 parts by weight of the total amount of components (A), (B), (C), and (D).

6. The curable polysiloxane composition according to claim 1, wherein component (A) comprises vinyl endblocked polyorganosiloxanes of the formula: 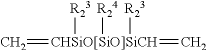
where R³ and R⁴ are selected from the group consisting of alkyl groups having from 1 to 6 carbon atoms per group, phenyl groups, and vinyl groups with at least 50 percent of R⁴ being methyl group.

7. The curable polysiloxane composition according to claim 1, wherein component (B) comprises a copolymer of trimethylsiloxy and methylhydrogensilicones or a copolymer of trimethylsiloxy, methylhydrogensilicones and dimethylsilicones.

8. The curable polysiloxane composition according to claim 1, wherein the hydrosilylation catalyst (C) is selected from the group consisting of platinum, palladium, rhodium, nickel, iridium, ruthenium catalysts and mixtures thereof.

9. The curable polysiloxane composition according to claim 1, wherein the flame retardant filler (D) is selected from the group consisting of aluminum hydroxide, magnesium hydroxide, hydromagnesite, ammonium polyphosphate, melamine polyphosphate, piperazine polyphosphate and mixtures thereof.

10. The curable polysiloxane composition according to claim 2, wherein the thickener (F) is selected from the group consisting of nanoclay, cellulose, polyacrylate and mixtures thereof.

11. The curable polysiloxane composition according to claim 3, wherein the hydrosilylation catalyst inhibitor (H) is selected from the group consisting of methylvinylcyclosiloxanes, tetravinyltetramethyl-cyclotetrasiloxane (vinyl D4), ethynylcyclohexanol (ECH) and mixtures thereof.

12. The curable polysiloxane composition according to claim 4, wherein the opacifier (I) is selected from the group consisting of carbon black, Fe₃O₄ and mixtures thereof.

13. A process for manufacturing a polysiloxane composite from the curable polysiloxane composition according to claim 1, the process comprising the following steps:
(I) mixing component (A) with components (B), (C), and (D) to form a silicone oil composite mixture (N), then adding component (E) and applying enough shearing and time to disperse the water (E) into water droplets in the silicone oil composite mixture (N), and thereby making a water-in-oil emulsion;
(II) heating the water-in-oil emulsion made in step (I) at certain temperature and time, which is enough to conduct curing of the silicone oil composite mixture (N) into a silicone matrix through the reaction between alkylene groups in component (A) and Si—H groups in component (B), and thereby making a cured wet composite with water droplets dispersed therein; and
(III) removing water from the cured wet composite made in step (II) by raising heating temperature above water's boiling point at the operation condition and allowing enough time to remove water from the cured wet_composite, and thereby obtaining a dried polysiloxane composite.

14. The process according to claim 13, wherein prior to step (I), thickened water (M) is previously prepared by adding (F) a thickener into component (E), and then in step (I), instead of component (E), the thickened water (M) is added into the silicone oil composite mixture (N) to make a water-in-oil emulsion.

15. The process according to claim 13, wherein the silicone oil composite mixture (N) further comprises (H) at least one hydrosilylation catalyst inhibitor and/or (I) at least one opacifier.

16. The process according to claim 13, wherein the dried polysiloxane composite obtained in step (III) has a mean cell size of ≤100 μm.

17. A thermal insulation material manufactured by the process according to claim 13.

18. An article comprising the polysiloxane composite obtained in the process according to claim 13.
